(19) United States
(12) Patent Application Publication
(10) Pub. No.: US 2009/0266124 A1
(43) Pub. Date: Oct. 29, 2009

(54) PANTOGRAPHIC-TYPE OPENING AND READING TOOL KIT

(76) Inventor: Abel Ferreira Dos Santos, Osasco (BR)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/439,999

(22) PCT Filed: Sep. 6, 2007
(86) PCT No.: PCT/BR2007/000231

§ 371 Date: Mar. 4, 2009

(30) Foreign Application Priority Data
Sep. 4, 2006 (BR) PI 0604031-4

(51) Int. Cl. E05B 19/20

(52) U.S. Cl. 70/394

(57) ABSTRACT

The present invention has the purpose of unlocking the cylinder into the pantographic-type locks and identify the code with no need to disassembly the cylinder, which consists on a pantographic-type key with a channel, where wires with angled curved-ends move with the purpose of aligning the throats set in respect to the cylinder tangent; and the jacket line where the handle of the pantographic-type key and piston are placed to move the wire with angled-ends. To perform the code reading, three metal plates and two labels will be used with the representation of the printed throats levels.

This invention has the purpose of unlocking the pantographic-type lock cylinders and identify the code without the need to disassembly the cylinder.

The methods to reproduce the keys, when loosing the pantographic cylinder keys are: opening the door by break methods and then disassembly the cylinder and thus the key notches levels are identified by means of the numbers printed on the throats forming the cylinder code; this method requires length of time and work to disassemble and assemble the door boarding and the automobile cylinder; although tools created with the purpose of performing the identification of the throats in the cylinders using milled notched keys were not able to read the new system which uses the pantographic-type key.

Due to such problems and with the purpose of overcoming them the pantographic-type opening and reading tool kit was developed, which is the subject of this patent, consisting on a pantographic-type key with a channel, where wires with angled and curved-ends move with the purpose of aligning the throats set in the cylinder tangent; and the jacket line where the handle of the pantographic-type key and piston fit in to move the angled-end wires,

In order to perform the code reading, three metal plates and two labels with the printed representation of the throats levels will be used.

The attached drawings show the disposition in a pantographic-type opening and reading tool kit, where:

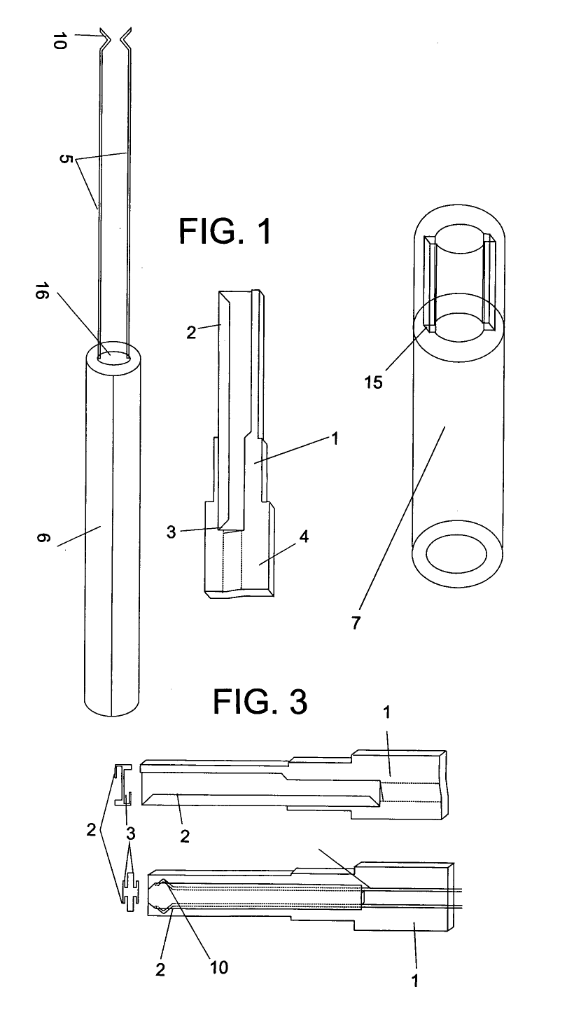

FIG. 1 shows the exploded tool

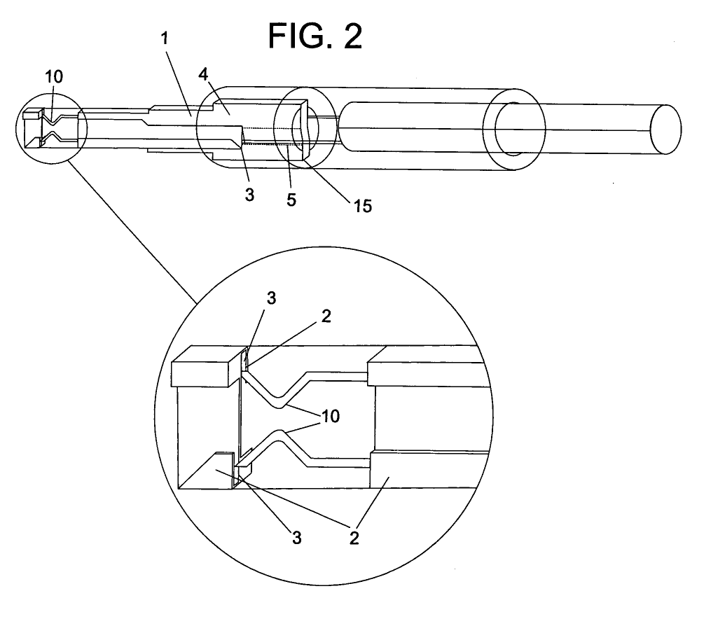

FIG. 2 shows the tool under perspective and details.

FIG. 3 shows some key profiles.

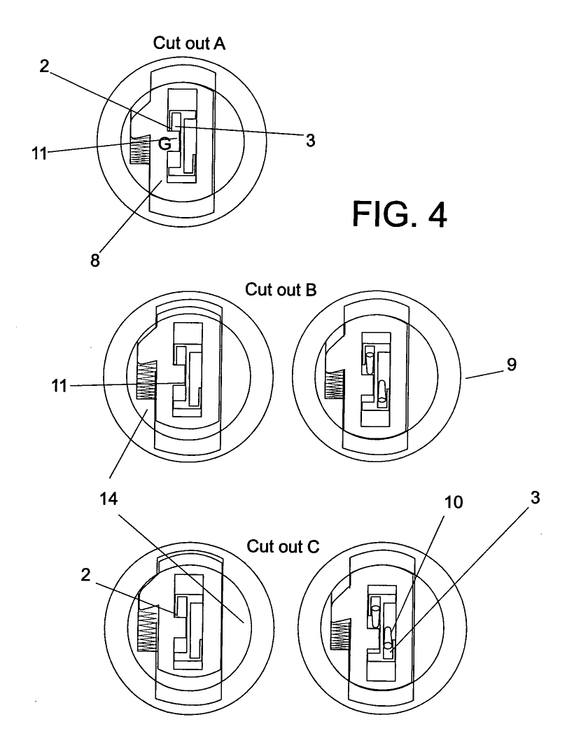

FIG. 4 shows the cylinder on A, B, C cuts being unlocked by the tool.

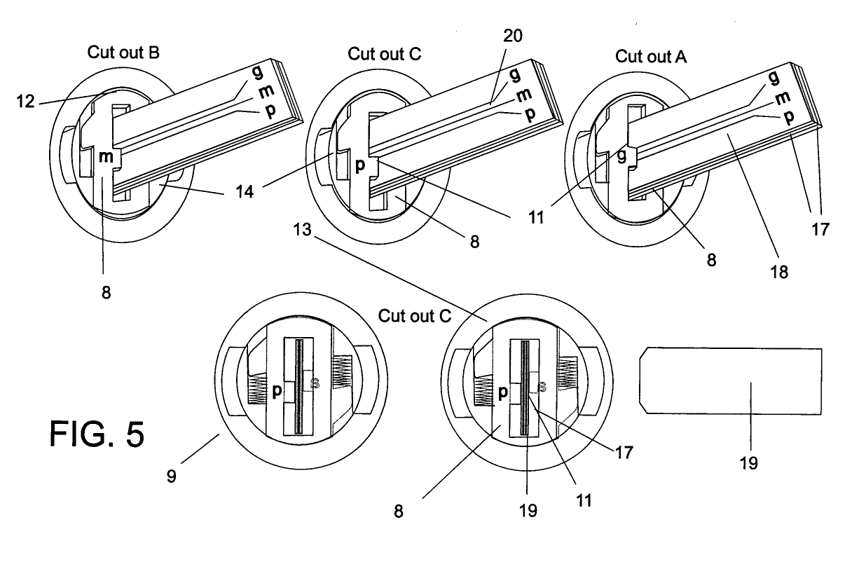

FIG. 5 shows the cylinder on A, B. C cuts performing the code reading.

As illustrated on the above mentioned figures, the pantographic-type opening and reading tool kit subject of the present patent, which is composed of pantographic-type key [1] which has bottoms (2), channel (3), head (4), wires (5), piston (6) and jacket (7); the bottoms (2) are in position to the throats (8) of the cylinder (9) as are the deepest notches of the cylinder original key (9), therefore when introduced into the cylinder (9), the bottoms (2) unlock the throats (8) which would be unlocked by the deepest notches of the original key, the channels (3) will guide the angled-end (10) wires (5); and in order to unlock the throats (8), which would be unlocked by the small and medium notches of the original key, the wires are moved through the piston (6) with a back and forth movement (on horizontal line), therefore, the angled ends (10) of the wires (5) when touching the sticks (11) of the throats (8) will displace the throats (8) (on vertical line) lifting the ends (12) of the throats (8) to the center tangent (13) unlocking it (9); the rotation movement will be transmitted to the center (14) through the jacket (7); the jacket (7) has a hole (15) where the head (4) of several pantographic-type key models fits; the piston (6) has an orifice (16) where the wire edge (5) is fixed with the angled end (10) and it moves into the jacket (7).

In order to perform the code reading, the cylinder (9) must be unlocked and the throats (8) ends (12) aligned with the center tangent (13), so as the sticks (11) of the throats (8) will be on the same position as if they were unlocked with the original key; at that moment two plates (17) are introduced which have the same length and width of the original key together with two stickers (18) glued on the plates (17) side; having the sticks (11) of the throats (8) into the center (14) with the grade (20) turned to the sticks (11) of the throats (8), a third plate is introduced as a die (19) between the two, so as the stickers (18) are pressed between the plates (17) and the sticks (11) of the throats (8) so as the sticks (11) of the throats (8) print a mark on the grade (20) of the stickers (18); when removing the plates from the cylinder the code combination will be revealed on the grade (20), enabling to manufacture a new key without the need to disassembly the cylinder.

1. “PANTOGRAPHIC-TYPE OPENING AND READING TOOL KIT” is featured by the fact of the pantographic key to have bottoms which are in position to the throats of the cylinder as the deepest notches of the cylinder original key.

2. “PANTOGRAPHIC-TYPE OPENING AND READING TOOL KIT” in accordance with claim 1 including the pantographic key with bottoms which unlocks the throats that would be unlocked by the deepest notches of the original key.

3. “PANTOGRAPHIC-TYPE OPENING AND READING TOOL KIT” according to claim 1 including the pantographic key with cannel which will lead the wires with angled ends.

4. “PANTOGRAPHIC-TYPE OPENING AND READING TOOL KIT” according to claim 1 including the pantographic key with different profiles to have a standard head which fits into the hole of the jacket.

5. “PANTOGRAPHIC-TYPE OPENING AND READING TOOL KIT” according to claim 1 including a opening tool with wires which unlocks the cylinder throats would be unlocked by the small and medium notches of the original key.

6. “PANTOGRAPHIC-TYPE OPENING AND READING TOOL KIT”—according to claim 1 including at tool kit which is able to perform the code reading by means of three metal plates and two labels with the representation of the printed cylinder throats level.
